(19) United States
(12) Patent Application Publication
(10) Pub. No.: US 2025/0364635 A1
(43) Pub. Date: Nov. 27, 2025

(54) BATTERY PACK ENCLOSURE WITH HEAT-CONDUCTING PLATE

(71) Applicant: 9351-0618 QUÉBEC INC., Sherbrooke (CA)

(72) Inventors: Mahmoodreza SALIM SHIRAZY, Boucherville (CA); Luc G. FRECHETTE, Sherbrooke (CA); Nicolas VOELTZEL, Lyon (FR); Samuel FILLION, Sherbrooke (CA); Mehdi HEDHILI, Sherbrooke (CA)

(21) Appl. No.: 18/874,692

(22) PCT Filed: Jun. 22, 2023
(86) PCT No.: PCT/CA2023/050874

§ 371 Date: Dec. 13, 2024

Related U.S. Application Data
(60) Provisional application No. 63/366,850, filed on Jun. 23, 2022.

(51) Int. Cl. H01M 10/6569; B60K 1/04; B60L 50/60; B60L 58/24; H01M 10/613; H01M 10/625; H01M 10/643; H01M 10/653; H01M 10/6554; H01M 10/6556; H01M 50/213; H01M 50/249; H01M 50/262

(52) U.S. Cl. CPC H01M 10/6569; B60K 1/04; B60L 50/66; B60L 58/24; H01M 10/613; H01M 10/625; H01M 10/643; H01M 10/653; H01M 10/6554; H01M 10/6556; H01M 50/213; H01M 50/249; H01M 50/262; H01M 2220/20

(57) ABSTRACT

The battery pack includes an enclosure including interconnected walls, one or more battery cells contained within the enclosure, and a heat-conducting plate defining one or more of the interconnected walls and being structurally load-bearing. The heat-conducting plate has a first section, the one or more battery cells in heat exchange relationship with the first section, and a second section in heat exchange relationship with the first section. The second section is in heat exchange relationship with an environment outside the enclosure for providing heat exchange between the one or more battery cells and the environment.

### CROSS-REFERENCE TO RELATED APPLICATIONS

This application claims priority from U.S. patent application 63/366,850 filed on Jun. 23, 2022, the entire contents of which are incorporated herein by reference.

### TECHNICAL FIELD

This disclosure generally relates to electric batteries and, more particularly, to heat transfer devices operable to remove heat from such batteries or provide heat to such batteries.

### BACKGROUND

Electric vehicles and other types of electric equipment may be powered by one or more electric batteries. Each battery typically includes a plurality of cells that are operatively connected to one another. The batteries generate heat when power is drawn from them and when power is provided to them (e.g., during charging). In some cases, operating batteries when a temperature of the batteries exceeds a maximum temperature threshold may impede their performance and, in some cases, may damage the batteries. Hot ambient temperatures may also contribute to elevated battery temperatures. Additionally, performance of the batteries may decrease when they are operated at a temperate below a minimum temperature threshold. While attempts to better regulate the temperature of batteries have been made, improvements are nonetheless sought.

### SUMMARY

There is accordingly provided a battery pack, comprising: an enclosure including interconnected walls; one or more battery cells contained within the enclosure; and a heat-conducting plate defining one or more of the interconnected walls and being structurally load-bearing, the heat-conducting plate having a first section, the one or more battery cells in heat exchange relationship with the first section, and a second section in heat exchange relationship with the first section, the second section in heat exchange relationship with an environment outside the enclosure for providing heat exchange between the one or more battery cells and the environment.

In certain embodiments, the battery pack as defined above and described herein also includes one or more of the following features, in whole or in part, and in any combination.

In certain aspects, the one or more battery cells are secured to the first section of the heat-conducting plate.

In certain aspects, the first section and the second section extend transversally to one another and each define a respective side of the enclosure.

In certain aspects, the first section includes a first plate and the second section includes a second plate, the heat-conducting plate including heat pipes mounted to both of the first plate and the second plate, a heat pipe of the heat pipes extending from a first end on the first plate to a second end on the second plate.

In certain aspects, the second plate has an inner side facing the one or more battery cells and an outer side opposed to the inner side, the outer side defining fins.

In certain aspects, the first plate and the second plate define grooves, the heat pipes received within the grooves.

In certain aspects, the first and second plates are made of a material having a thermal conduction of at least 10 W/mK.

In certain aspects, the heat-conducting plate includes: a first casing and a second casing defining a cavity therebetween; a core assembly having a wicking layer adjacent an inner side of the first casing, and a vapor core, the wicking layer and the vapor core received within the cavity; and a working fluid within the cavity.

In certain aspects, one or more coolant conduits embedded within the second section, the coolant conduits flowing a coolant and in fluid communication with a cooling system for extracting heat from the coolant.

In certain aspects, one or more coolant conduits, the second section wrapped around the one or more coolant conduits, the coolant conduits flowing a coolant and in fluid communication with a cooling system for extracting heat from the coolant.

In certain aspects, fins protrude from the second section of the heat-conducting plate.

In certain aspects, the battery pack includes a third section, the first and third section connected together via the second section, the first, second, and third sections defining a U-shape, the one or more battery cells located between the first and third sections.

In certain aspects, the first section includes four lateral sections each extending generally transversally from a respective edge of the second section, the four lateral sections and the second section defining the enclosure.

In certain aspects, a battery support is secured to the first section, the battery support defines a plurality of cell-engaging protrusions each defining a cavity receiving a respective one of the one or more battery cells.

There is also provided an electric vehicle, comprising: a chassis including a frame having frame members; and a battery pack secured to the frame, the battery pack having: an enclosure including interconnected walls; one or more battery cells contained within the enclosure; and a heat-conducting plate defining one or more of the interconnected walls and being structurally load-bearing and configured to increase a stiffness of the frame, the heat-conducting plate having a first section, the one or more battery cells in heat exchange relationship with the first section, and a second section in heat exchange relationship with the first section, the second section in heat exchange relationship with an environment outside the enclosure for providing heat exchange between the one or more battery cells and the environment.

In certain embodiments, the electric vehicle as defined above and described herein also includes one or more of the following features, in whole or in part, and in any combination.

In certain aspects, one of the frame members is secured to another of the frame members via the heat-conducting plate.

In certain aspects, the heat-conducting plate has a bottom face exposed to an environment outside the electric vehicle.

In certain aspects, a stiffness of the frame is increased by the heat-conducting plate by at least 10%.

In certain aspects, the electric vehicle includes brackets, the heat-conducting plate secured to the frame members via the brackets.

In certain aspects, a load path extends from the frame members to the heat-conducting plate via the brackets, the brackets configured to support a weight of battery pack.

In some aspects, the heat-conducting plate is configured to support a weight of the one or more battery cells.

In another aspect, there is provided a battery pack, comprising: an enclosure including a interconnected walls; one or more battery cells contained within the enclosure; and a heat-conducting plate defining one or more of the interconnected walls and being structurally load-bearing, the heat-conducting plate having a first section, the one or more battery cells in heat exchange relationship with the first section, and a second section in heat exchange relationship with the first section, the second section in heat exchange relationship with an environment outside the enclosure for evacuating heat from the one or more battery cells.

The battery pack described above may include any of the following features, in any combinations.

In some embodiments, the one or more battery cells are secured to the first section of the heat-conducting plate.

In some embodiments, the first section and the second section extend transversally to one another and each define a respective side of the enclosure.

In some embodiments, the first section includes a first plate and the second section includes a second plate, the heat-conducting plate including heat pipes mounted to both of the first plate and the second plate, a heat pipe of the heat pipes extending from a first end on the first plate to a second end on the second plate.

In some embodiments, the second plate has an inner side facing the one or more battery cells and an outer side opposed to the inner side, the outer side defining fins.

In some embodiments, the first plate and the second plate define grooves, the heat pipes received within the grooves.

In some embodiments, the first and second plates have a thickness of at least 1 mm.

In some embodiments, the first and second plates are made of a material having a thermal conduction of at least 10 W/mK.

In some embodiments, the heat-conducting plate includes: a first casing and a second casing defining a cavity therebetween; a core assembly having a wicking layer adjacent an inner side of the first casing, and a vapor core, the wicking layer and the vapor core received within the cavity; and a working fluid within the cavity.

In some embodiments, one or more coolant conduits are embedded within the second section, the coolant conduits flowing a coolant and in fluid communication with a cooling system for extracting heat from the coolant.

In some embodiments, the second section wrapped around the one or more coolant conduits, the coolant conduits flowing a coolant and in fluid communication with a cooling system for extracting heat from the coolant.

In some embodiments, fins are protruding from the second section of the heat-conducting plate.

In some embodiments, the first and third section connected together via the second section, the first, second, and third sections defining a U-shape, the one or more battery cells located between the first and third sections.

In some embodiments, the first section includes four lateral sections each extending generally transversally from a respective edge of the second section, the four lateral sections and the second section defining the enclosure.

In some embodiments, a battery support is secured to the first section.

In some embodiments, the battery support defines a plurality of cell-engaging protrusions each defining a cavity receiving a respective one of the one or more battery cells.

In some embodiments, a controller is operatively connected to the one or more battery cells, the controller in heat exchange relationship with the first section.

### BRIEF DESCRIPTION OF THE DRAWINGS

Reference is now made to the accompanying figures in which:

FIG. 1 is a three dimensional view of a battery pack in accordance with one embodiment;

FIG. 2 is a three dimensional exploded view of the battery pack of FIG. 1;

FIG. 3 is a three dimensional view of a heat-conducting plate of a battery enclosure of the battery pack of FIG. 1;

FIG. 4 is a side view of a portion of the heat-conducting plate illustrating fins thereof;

FIG. 5 is a three dimensional view of an enclosure of a battery pack in accordance with another embodiment;

FIG. 6 is a three dimensional partially cut-away view of a heat-conducting plate in accordance with another embodiment to be used with the enclosure of FIG. 5;

FIG. 7 is a schematic cross-sectional view of a layered structure of the heat-conducting plate of FIG. 6;

FIG. 8 is a schematic cross-sectional view of the heat-conducting plate of FIG. 6 illustrating a process of heat exchange;

FIG. 9 is a three dimensional view of the heat-conducting plate of FIG. 5 coupled with coolant conduits in accordance with one embodiment;

FIG. 10 is a cross-sectional view taken along line I-I on FIG. 9;

FIG. 11 is a three dimensional view of the heat-conducting plate of FIG. 5 coupled with coolant conduits in accordance with another embodiment;

FIG. 12 is a three dimensional view of the heat-conducting plate of FIG. 5 coupled with a coolant conduit in accordance with yet another embodiment;

FIG. 13 is a three dimensional view of the heat-conducting plate of FIG. 5 coupled with fins;

FIG. 14 is a three dimensional view of the heat-conducting plate of FIG. 5 coupled with a coolant conduit in accordance with yet another embodiment;

FIG. 15 is a three dimensional view of a battery pack having battery cells partially enclosed by a heat-conducting plate in accordance with another embodiment;

FIG. 16 is a three dimensional view of a heat-conducting plate in accordance with another embodiment;

FIG. 17 is a three dimensional view of an enclosure having a heat-conducting plate in accordance with yet another embodiment;

FIG. 18 is a three dimensional view of a heat-conducting plate in accordance with another embodiment;

FIG. 19 is a three dimensional view of the heat-conducting plate of FIG. 5 coupled with a battery support in accordance with one embodiment;

FIG. 20 is a side view of the battery support of FIG. 19 with battery cells secured thereto; and

FIG. 21 is a schematic top view of a vehicle equipped with any of the battery packs of FIGS. 1-20.

### DETAILED DESCRIPTION

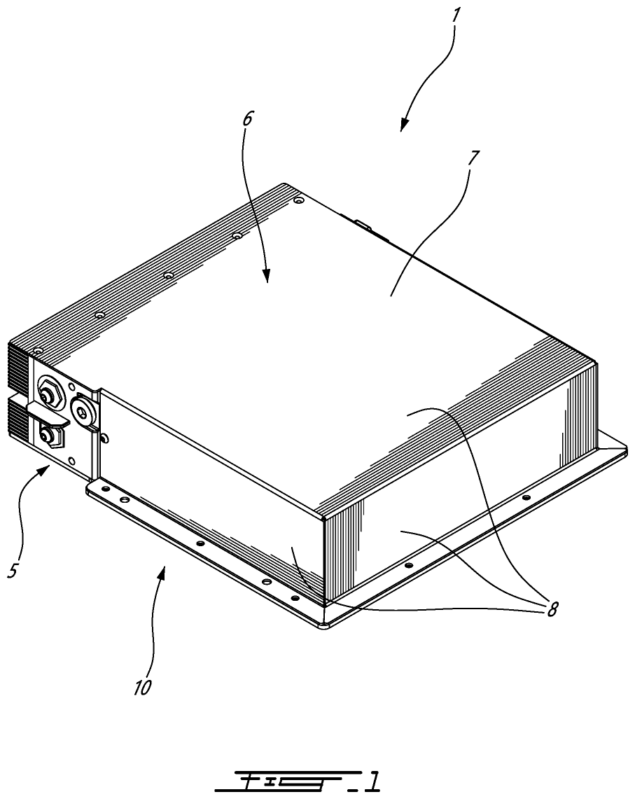

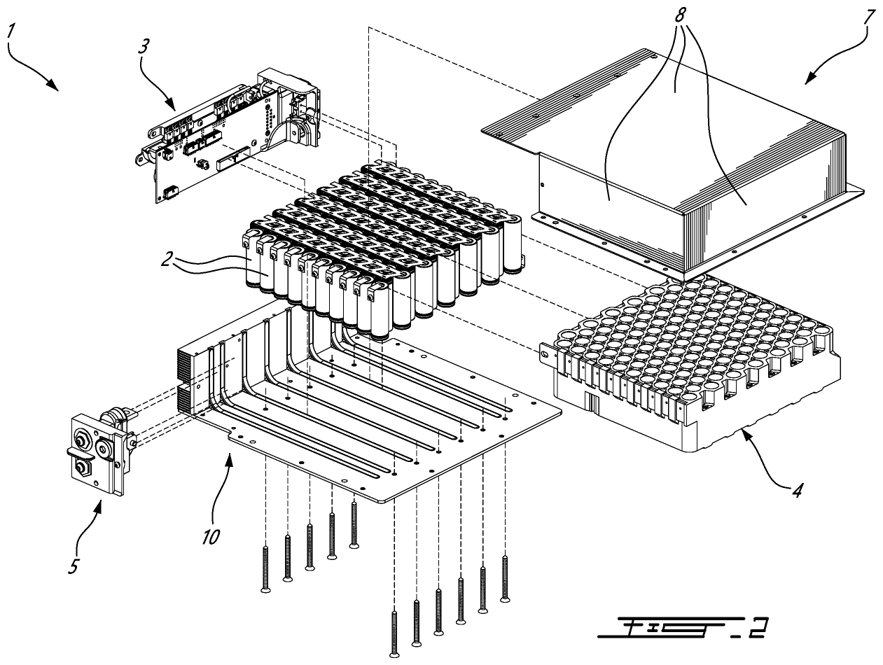

Referring to FIGS. 1-2, a battery pack (or battery “module”) is shown at 1 and includes one or more battery cells 2, a controller 3, also referred to as a battery management system (BMS), operatively connected to the one or more battery cells 2, a support 4 for securing the one or more battery cells 2 together, and a connector 5 operatively connected to the controller 3 and the one or more battery cells 2. The connector 5 may be used as an interface to connect the battery pack 1 to a device in need of electrical power, such as, for instance, an electrical vehicle. The battery cells 2 are depicted here as being cylindrical. However, other shapes for battery cells, such as prismatic or pouch, are contemplated. An electric vehicle may include a battery pack having multiple modules combined together, in parallel to simply increase the storage capacity or in series to also increase the voltage. Each of these modules may include a plurality of battery cells.

Referring more particularly to FIG. 2, the battery pack 1 includes an enclosure 6 that is sized to contain the one or more battery cells 2, the controller 3, and the support 4. The enclosure 6 is herein provided in the form of a rectangular prism having six sides. The enclosure 6 includes a main casing 7 having a plurality of interconnected side walls 8 defining multiple (e.g. 3, 4 or more) of the six sides of the enclosure 6. In some embodiments, the main casing 7 may define any number of sides of the enclosure 6. A heat-conducting plate 10 defines at least some or all of the remaining sides of the enclosure 6. It will be appreciated that the enclosure 6 may have any suitable shapes and that the main casing 7 and the heat-conducting plate 10 cooperate with one another to define the sides of the enclosure 6. The main casing 7 may define any number of sides of the enclosure 6, the heat-conducting plate 10 may define at least part of the remaining sides of the enclosure 6.

The heat-conducting plate 10 may therefore have two functions: 1) it structurally defines a portion of the enclosure 6; and 2) it provides heat-conducting exchange relationship between the one or more battery cells 2 and an environment outside the enclosure 6. The heat-conducting plate 10 is therefore constructed with materials having sufficient stiffness to be able to withstands loads imparted to the battery pack 1 during use. In the embodiment shown, the electronics of the battery pack 1 may be secured to the heat-conducting plate 10. This may allow the electronics and microprocessor to be cooled by contact with the heat-conducting plate 10, similar to the battery cells. In other words, in the embodiment shown, the controller 3 may be in heat exchange relationship (e.g., thermal contact) with the heat-conducting plate 10 to be cooled thereby.

Referring now to FIG. 3, the heat-conducting plate 10 is described in further detail. In the embodiment shown, the heat-conducting plate 10 includes a first section 11 and a second section 12 secured to the first section 11 and extending generally transversally to the first section 11. In the present embodiment, the first section 11 and the second section 12 include respectively a first plate 13 and a second plate 14. The first plate 13 and the second plate 14 may be made of aluminum or any other suitable material having both of a sufficient stiffness to provide the required structural integrity to the battery pack 1 and a sufficient heat conduction to be able to transfer heat from the one or more battery cells 2 as will be described further below. The material of the plates 13, 14 may have a thermal conduction of at least 10 W/mK. In some embodiments, the thermal conduction of the material of the plates 13, 14 is of at least 100 W/mK, preferably about 200 W/mK. The first and second plates 13, 14 may be structurally load-bearing.

In the context of the present disclosure, the expression “structurally load-bearing” implies that the first and second plates 13, 14 may be able to withstands loads imparted to the battery pack 1 during use. For instance, the loads may be acceleration/deceleration forces, torsion forces imparted by a frame of a vehicle to which the battery pack 1 is secured, flexion forces imparted by the frame, weight of the battery cells 2, and so on. A wall or plate may be considered to be load bearing if it retains its shape with the application of those loads during normal use of the battery pack 1. A wall or plate may be considered to have retained its shape if, although some deformations may be exhibited by the plate or wall, these deformations remained within the elastic regime of deformation of the plate or wall and are not permanent. These deformations do not impair operation of the battery pack 1. For example, a thermal contact may be required between the battery cells and the heat-conducting plate 10. Some deformation may be acceptable when a flexible thermal interface material (TIM) is used between the battery cells and the heat-conducting plate 10. The TIM is typically a paste or a flexible film, which may accommodate up to approximately 100 micrometers. The stiffness of the heat-conducting plate is selected to be sufficient to keep the deformation below this value when subjected to the mechanical loads. The expression “structurally load-bearing” may imply that the plates 13, 14 or other component is able to withstand a flexion force, and/to withstand a torsion force, and/or to withstand a shearing force. The expression “withstand” implies that a deformation of the plates 13, 14 when subjected to the flexion force, torsion force, or shearing force, remains within the elastic regime.

The structural nature of the heat-conducting plate 10 may in certain instances permit the removal of other components that would otherwise be required for a typical non-structural counterpart. For example, in addition to its use for heat transfer, the heat-conducting plate 10 may be used to structurally interconnect two different components of a vehicle or of another system.

Therefore, in addition to its thermal management function, the heat-conducting plate 10 described above, and any of the heat-conducting plates described herein, may be used as a casing portion of the battery module. This therefore may allow the removal of a component. The heat-conducting plates may form a bottom casing of the battery modules and be configured to support the weight of the cells and to protect components of the battery modules (e.g., cells, electronics, etc) from forces applied to a frame of a vehicle for instance during normal use of said vehicle. More detail about this aspect are provided below with reference to FIG. 21.

The first plate 13 may be monolithically integrated with the second plate 14 as a single part. An angle can be created between the first plate 13 and the second plate 14 by bending a flat plate, by casting, or by machining. The first plate 13 may be secured to the second plate 14 via brazing or welding. In some embodiments, brackets may be used to secure the first plate 13 to the second plate 14. The first plate 13 may be fastened to the second plate 14.

The first plate 13 defines first grooves 13A and the second plates 14 defines second grooves 14A. The first and second grooves 13A, 14A communicate with one another and are sized to accept heat pipes 15 that longitudinally run along both of the first and second plates 13, 14. More specifically, each of the heat pipes 15 has a section overlapping the first plate 13 and a second section overlapping the second plate 14. The heat pipes 15 may therefore define elbows 15A to follow a corner defined at the intersection of the first and second plates 13, 14. The heat pipes 15 may be any suitable heat pipes. The heat pipes 15 may transfer heat by a change of phase (e.g., from liquid to gaseous and vice-versa) of a fluid contained within the heat pipes 15. The heat pipes 15 may be adhered within the first and second grooves 13A, 14A using, for instance, a heat transfer adhesive, glue (e.g, epoxy), mechanical fastener, or by metallic brazing.

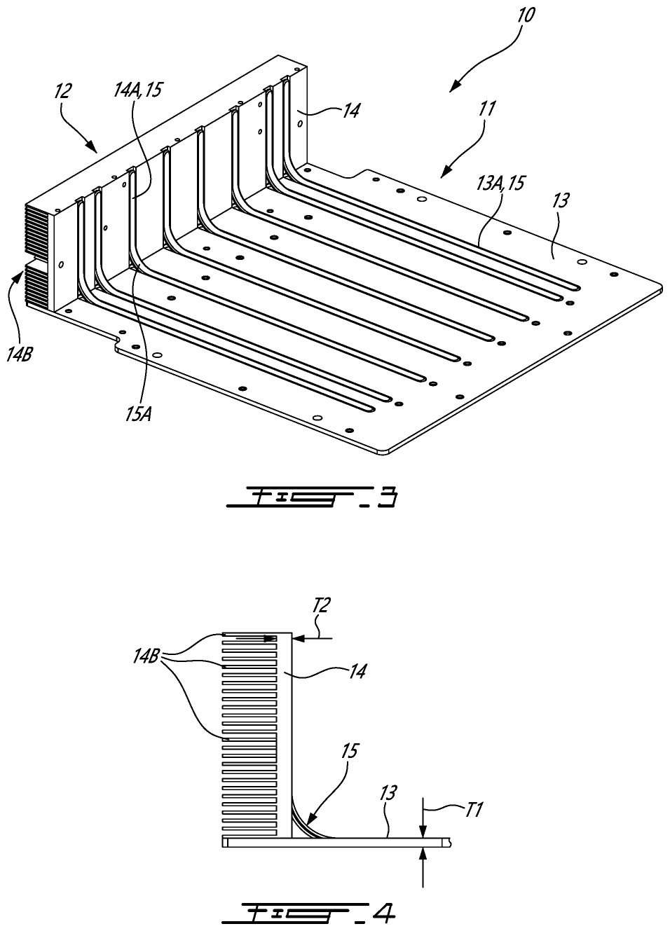

Referring now to FIG. 4, the second section 12 further defines fins 14B secured to an outer side of the second plate 14; the outer side facing away from the one or more battery cells 2. The fins 14B extend in a direction being substantially normal to the second plate 14 and away therefrom. The fins 14B extend substantially transversally to the heat pipes 15. In the embodiment of FIG. 4, the fins 14B extend longitudinally and parallel to the first plate 13. Alternatively, the fins 14B may extend vertically and perpendicularly to the first plate 13. The fins 14B may extend at any suitable angle. Having the fins 14B extending parallel to the first plate 31 may allow the fins 14B to receive heat from the heat pipes 15 at a plurality of locations along a length of their bases. The heat from the heat pipes 15 may be transferred to the second plate 14 by conduction, from the second plate 14 to the fins 14B by conduction, and from the fins 14B to an environment outside the enclosure 6 by convection.

A thickness T1 of the first plate 13 may be from about 1 mm to about 5 mm. A thickness T2 of the second plate 14 may be from about 1 mm to about 5 mm. The first and second plates 13, 14 may be made of aluminum or any other suitable material such as stainless steel.

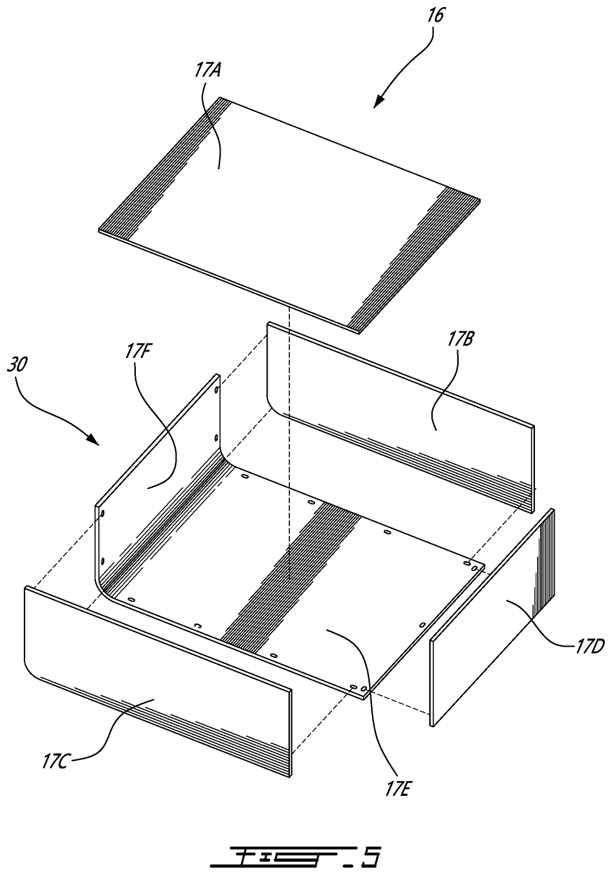

Referring now to FIG. 5, another embodiment of an enclosure for the battery pack 1 of FIG. 1 is shown at 16. The enclosure 16 includes four interconnected side walls and a heat-conducting plate 30. The interconnected side walls includes a top plate 17A, a first side plate 17B, a second side plate 17C opposed to the first side plate 17B, and a first end plate 17D. The heat-conducting plate 30 defines a bottom plate 17E and a second end plate 17F of the enclosure 16 opposite the first end plate 17D. The plates 17A, . . . , 17F of the enclosure 16 are interconnected to one another using any suitable means to enclose a volume sized for receiving the one or more battery cells 2 (FIG. 1). The plates 17A, . . . , 17F may be sealingly engaged to one another to protect the battery cells 2 contained within the enclosure 16 from water or other debris.

Referring now to FIG. 6, another embodiment of the heat-conducting plate is shown at 30. The heat-conducting plate 30 includes a first section 31 and a second section 32 generally transverse to the first section 31 such that the heat-conducting plate 30 has a L-shape. The two sections 31, 32 of the heat-conducting plate 30 may be structurally load-bearing as defined herein above. Moreover, the load-bearing characteristic of the heat-conducting plate 30 may allow the heat-conducting plate 30 to resist a force to rotate the two sections 31, 32 one relative to the other. The first section 31 may define the bottom plate 17E of the enclosure 16 and the second section 32 may define the second end plate 17F of the enclosure 16. The first section 31 may be in contact with the one or more battery cell 2 (FIG. 2). In other words, the first section 31 is in heat exchange relationship with the one or more battery cells 2. Although the heat-conducting plate 30 depicted in FIG. 6 has a bend therein to form its L-shape, it is to be understood that the heat-conducting plate 30 as described herein may also be a flat (i.e. non-bent) plate. More detail about the heat-conducting plate 30 are presented in U.S. patent application No. 63/290,752, the entire contents of which are incorporated herein by reference. The battery cells 2 may be directly bonded to the heat-conducting plate 30. Thus, the heat-conducting plate 30 may act as an electrical busbar. This may be the case also for the heat-conducting plate 10 of FIG. 1.

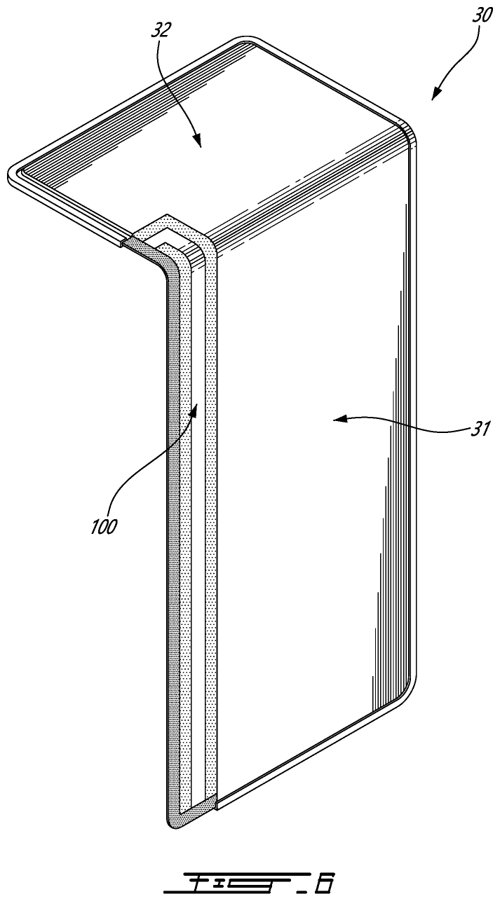

Referring more particularly to FIG. 7, the heat-conducting plate 30 has a layered structure 100. The layered structure 100 includes an outer envelope or casing that is composed of a first casing portion 101 and a second casing portion 102 (hereinafter simply referred to as first casing 101 and second casing 102). A cavity 103 is defined between the first casing 101 and the second casing 102. The first casing 101 is joined to the second casing 102 along a periphery of the heat-conducting plate 30. More specifically, a first peripheral flange of the first casing 101 abuts and is sealingly fixed to a second peripheral flange of the second casing 102 along a full uninterrupted perimeter of the first and second casings 101, 102. In some embodiments, the perimeter may be interrupted by a filling tube, which may be used to pull a vaccum in the cavity 103, injecting water inside, and then sealed to maintain the partial vacuum inside. This filling tube may be located along the perimeter seal between the flanges. The first casing 101 is joined to the second casing 102 via the first and second peripheral flanges or peripheries. In another embodiment, the water is injected first and the two plates are secured into a low pressure environment, as described for example in International patent application No. PCT/CA2022/051825, the entire contents of which are incorporated herein by reference.

The structural load-bearing capabilities of the heat-conducting plate 30 may be provided by one or more of the first casing 101 and the second casing 102. In other words, the first casing 101 and/or the second casing 102 may have a thickness of at least from about 1 mm to about 5 mm and may be made of aluminum or steel, or any other material able to render the plate structurally load-bearing. It will be appreciated that the thickness may be selected as a function of the structural characteristic and the thermal properties (e.g., thermal conductivity) of the material used. In some embodiments, at least a portion of the load-bearing capability of the heat-conducting plate 30 may be provided by the two flanges of the first casing 101 and second casing 102 being secured to one another and providing an effective thickness corresponding to a thickness of the flange of the first casing 101 plus a thickness of the flange of the second casing 102.

The heat-conducting plate 30 also includes, within the cavity 103 defined within the outer casing formed by the first and second casings 101, 102, a core assembly including a first wicking layer 104 and a second wicking layer 105. The first wicking layer 104 is disposed adjacent the first casing 101. The second wicking layer 105 is disposed adjacent the second casing 102. The core assembly further includes a vapor core 106 disposed between the first wicking layer 104 and the second wicking layer 105. Accordingly, a sandwiched core sub-assembly fills the cavity 103 defined between the inner surfaces of the walls of the first and second casings 102, the sandwiched core sub-assembly being composed of the first wicking layer 104, the vapor core 106, and the second wicking layer 105. In an alternative embodiment, only one wicking layer may be used, such that the core assembly includes a vapor core and one wicking layer. The wicking layer may be preferably positioned on the inner wall of the casing being in contact with the battery cells such that the liquid in the wicking layer is able to evaporate to absorb the heat generated by the battery cells. The portion of the casing in contact with the cells, and that faces the battery cells, may be thinner to facilitate heat transfer across the casing. Also, the opposite casing, which faces away from the battery cells, may be thicker to sustain the mechanical loads, provide the structural support, and may increase the thermal resistance between the cells and the environment to limit losses of thermal energy of the cells in cold temperatures (e.g., winter).

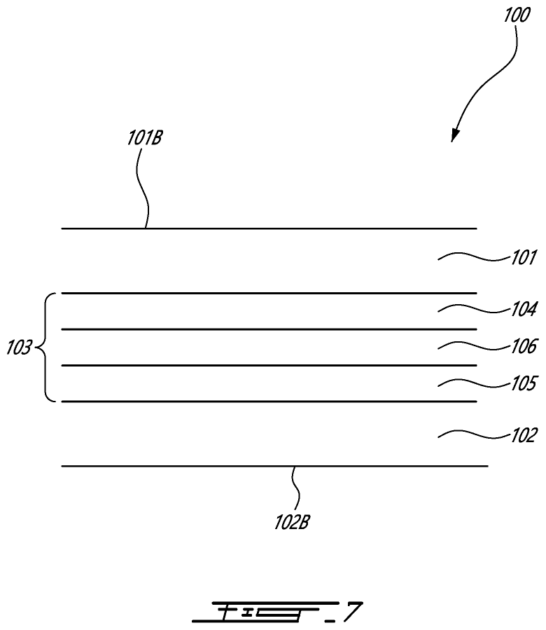

Referring now to FIG. 8, the different components of the heat-conducting plate 30 having been described above, the operation of the heat-conducting plate 30 is now described.

The heat-conducting plate 30 has a first end 30A, which may be in contact with the one or more battery cells 2 for receiving heat therefrom. A second end 30B may be in contact with a heat sink or cold plate to extract the heat. The heat-conducting plate 30 is operable to move the heat from the first end 30A to the second end 30B. To this end, the working fluid is present in liquid form in the first and second wicking layers 104, 105. When exposed to the heat, the working fluid evaporates in a gaseous phase and migrates, along arrows A1, into the cavity 103, which contains the vapor core 106. The working fluid in gaseous phase then migrates along arrows A2 along the vapor core 106 towards the second end 30B of the heat-conducting plate 30. Since the second end 30B is colder than the first end 30A, the working fluid condensates back into a liquid phase and gets absorbed by the first and second wicking layers 104, 105 along arrows A3. Then, the working fluid moves, by capillary action, along the first and second wicking layers 104, 105 and migrates along arrows A4 back towards the first end 30A and the process starts over again. The heat-conducting plate 30 therefore removes heat from the first end 30A by evaporating the working fluid and transfers heat to the second end 30B by condensing the working fluid. These phase changes result in heat being moved from the first end 30A to the second end 30B. In an application where the component (i.e. battery) must be heated instead of cooled, then the inverse behavior and direction of the liquid and vapor flows are inverted, without any change to the plate structure.

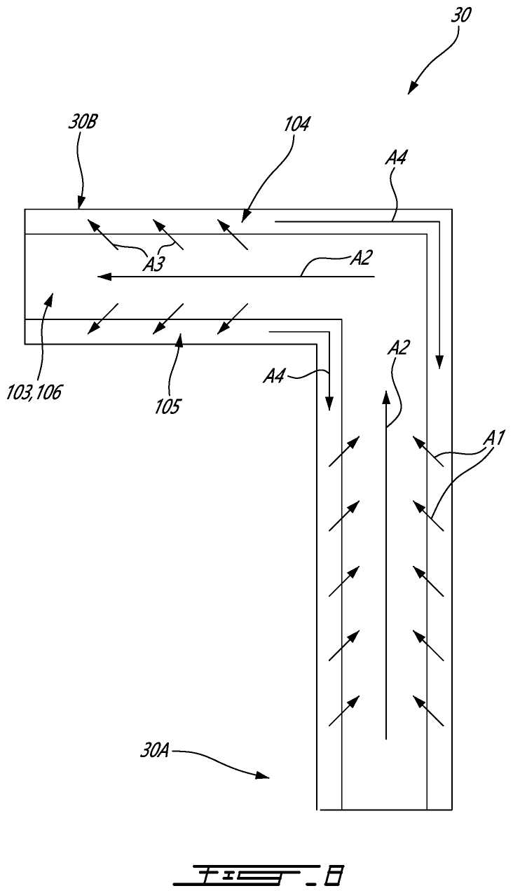

Referring now to FIGS. 9-10, in the embodiment shown, the second section 32 of the heat-conducting plate 30 may be operatively connected to a cooling system 110. More specifically, a plurality of conduits 111 extend through the second section 32 of the heat-conducting plate 30. The plurality of conduits 111 may be received between the two wicking layers 104, 105 and disposed within the cavity 106. The conduits 111 are in fluid flow communication with the cooling system 110 and flow a coolant, such as a liquid coolant, to and from the second section 32. In other words, the coolant may flow form the cooling system 110 within the conduits 111 and reach the second section 32 of the heat-conducting plate 30 where heat of the second section 32 is transferred to the coolant. The coolant then flows out of the second section 32 via the conduits 111 and reaches the cooling system 110 where heat may be extracted from the coolant. In some embodiments, the cooling system 110 may include a heat exchanger having first conduits fluidly connected to the conduits 111 and second conduits in heat exchange relationship with the first conduits. The second conduits may be in heat exchange relationship with a medium (e.g., ambient air) at a lower temperature. The conduits 111 include three conduits in the present embodiment, but more or less than three conduits may be used. The conduits 111 may be parallel to one another and extend substantially transversally relative to the first section 31. Other configurations are contemplated.

It may be challenging to integrate the flow channels into the heat-conducting plate since said plate may need to be sealed hermetically. These flow channels may alternatively be affixed against the outer wall. The flow channels may then be outside the cavity of the heat-conducting plate and may be in direct contact or monolithically fabricated as part of one or both of the outer walls. Alternatively, channels may be defined in a plate and said plate may be attached the outer wall of the heat-conducting plate. If the outer wall is thick enough, the channels may be formed directly in the outer wall.

The cooling system 110 may alternatively include a heat pump 112 in which the coolant changes phase from liquid to gaseous within the second section 32, which then acts as an evaporator. The coolant in its gaseous phase then flows through a compressor and then through a condenser where it changes phase from gaseous to liquid. The coolant than expands through an expansion valve to revert back into the gaseous phase and becomes cooler and returns to the second section 32 via the conduits 111.

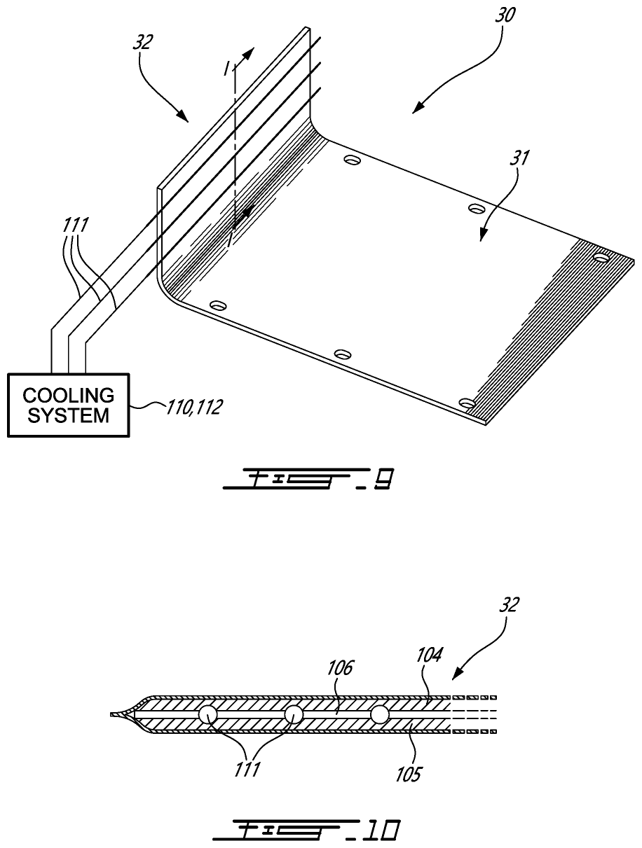

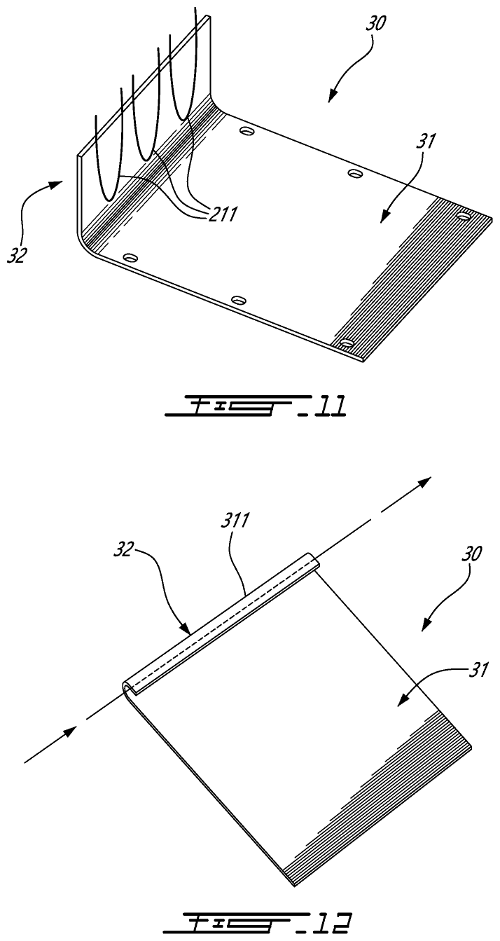

Referring to FIG. 11, in the embodiment shown, a plurality of conduits 211 extend within the second section 32 of the heat-conducting plate 30. In the present case, each of the conduits 211 defines a U-shape within the second section 32 of the heat-conducting plate 30. These conduits 211 may be in fluid flow communication with the cooling system 110/heat pump 112 described above. Referring to FIG. 12, in the present embodiment, the second section 32 of the heat-conducting plate 30 is wrapped around a conduit 311 that flows the coolant. This conduit 311 may be in fluid flow communication with the cooling system 110/heat pump 112 described above. Referring to FIG. 13, in the embodiment shown, fins 411 are protruding from the second section 32 of the heat-conducting plate 30. The fins 411 may extend from both sides of the heat-conducting plate 30: towards the battery cells 2 (FIG. 2) and away therefrom. A cooling air flow may pick up heat from the fins 411 via convection. Although bent are illustrated, the heat-conducting plate 30 may alternatively be straight, with the fins protruding above and below, or only on one side.

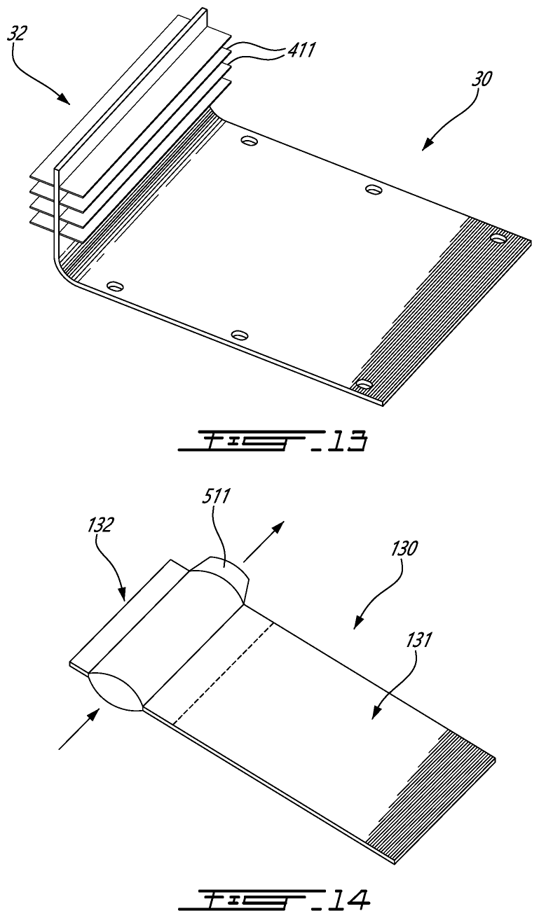

Referring to FIG. 14, a heat-conducting plate in accordance with another embodiment is shown at 130. The heat-conducting plate 130 may define one of the side walls of the enclosure of the battery pack as previously discussed. The heat-conducting plate 130 has two sections 131, 132 that may be co-planar. That is, the two sections 131, 132 may be parallel to one another. They may also be angled at 90 to each other, as shown in other embodiments. A conduit 511 may be embedded within the second section 132. The conduit 511 may extend within the vapor core 106 (FIG. 7) of the heat-conducting plate 130. This conduit 511 may have a diameter greater than a thickness of the second section 132 of the heat-conducting plate 130. Thus, the casing portions of the heat-conducting plate 130 may be curved to accommodate this conduit 511. As previously discussed, this conduit 511 may flow a coolant to pick up heat from the second section 132 of the heat-conducting plate 130. Stated differently, this conduit 511 may be in fluid flow communication with the cooling system 110/heat pump 112 described above.

Referring now to FIG. 15, another embodiment of a heat-conducting plate is shown at 230. The heat-conducting plate 230 is used to define part of a enclosure for receiving battery cells 20, herein provided in the form of planar modules. The heat-conducting plate 230 includes a first section 231, a second section 232, and a third section 233 and substantially defines a U-shape. The first and second sections 231, 232 are opposed one another and connected together via the third section 233. The same layered structure 100 described above with reference to FIG. 7 may be used for each of the sections 231, 232, 233.

Heat may be transferred from the battery cells 20 to the first and second sections 231, 232. The heat may then move to the third section 233 as explained above with reference to FIG. 8. The third section 233 may be in heat exchange relationship with another medium (e.g., ambient air) to evacuate the heat. A cooling system 110 as described above including conduits 111 may be coupled to the third section 133 to extract heat therefrom.

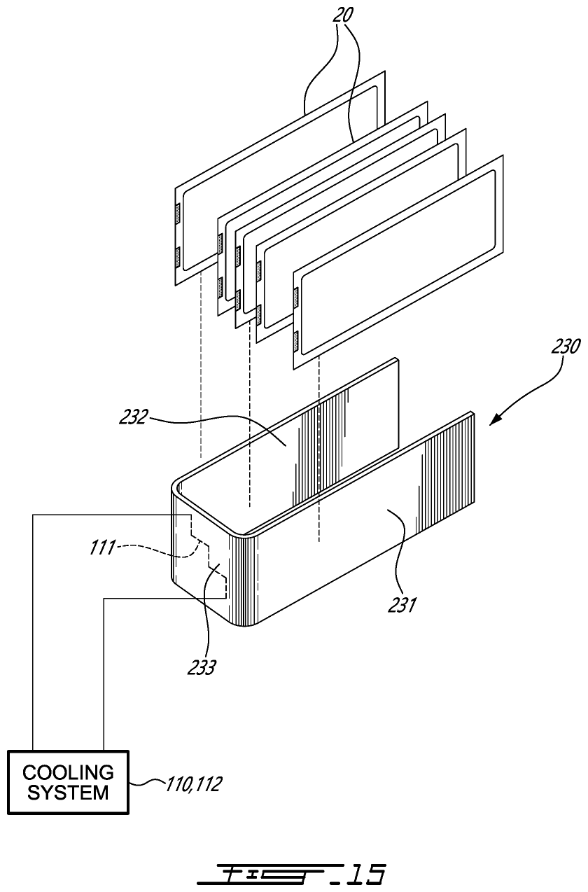

Referring to FIG. 16, another embodiment of a heat-conducting plate is shown at 330. For the sake of conciseness, only features differing from the heat-conducting plate 30 of FIG. 6 are described below. In the present embodiment, the heat-conducting plate 330 has brackets 333 disposed on opposite edges 331A of the first section 331. Three brackets 333 are disposed on each sides, but more or less brackets are contemplated. These brackets may allow the battery to be attached to the vehicle, since the heat-conducting plate may also serve as a mechanical support for the cells and other components. A load path may extend from the frame members to the heat-conducting plate via the brackets. The brackets may thus be configured to support a weight of battery pack and any other forces imparted thereto, such as acceleration, vibrations, impact, and so on. The brackets may thus be load-bearing as defined herein above and may not be used solely for the purpose of maintaining the battery pack immobile.

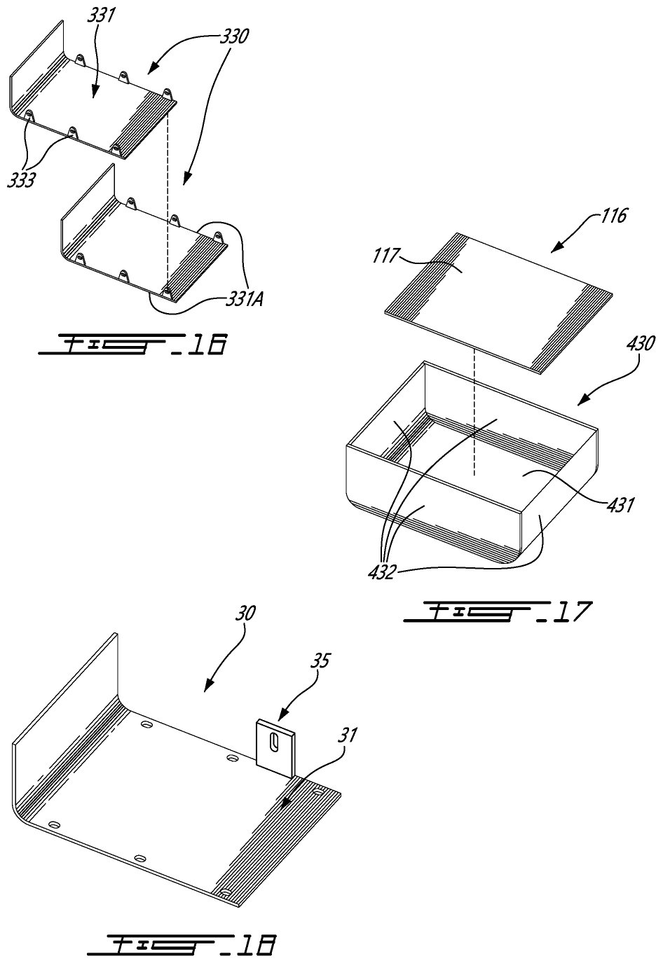

Referring now to FIG. 17, another embodiment of an enclosure is shown at 116. The enclosure 116 includes six sides. Five of those six sides are defined by a heat-conducting plate 430 and the sixth of those six sides is defined by a cover 117. The heat-conducting plate 430 includes a bottom section 431 on which the battery cells 2 (FIG. 2) are mounted, and four lateral sections 432 in heat exchange relationship with the bottom section 431. Each of the four lateral sections 432 extends substantially transversally from an edge of the bottom section 431. The same layered structure 100 described above with reference to FIG. 7 may be used for the bottom and lateral sections 431, 432 of the heat-conducting plate 430. Heat received from the battery cells 2 and transferred to the bottom section 431 may then the transferred to an environment outside the enclosure 116 via the four lateral sections 432. A cooling system such as the one described above with reference to FIG. 9 may be operatively coupled to the lateral sections 432. Any number of walls of the enclosure may be a condenser.

Referring to FIG. 18, in the embodiment shown, a bracket 35 is secured to the first section 31 of the heat-conducting plate 30. This bracket 35 may be used to secure the enclosure to adjacent structure, such as a frame of an electric vehicle, via the heat-conducting plate 30. The bracket 35 may be monolithically fabricated as part of the heat-conducting plate.

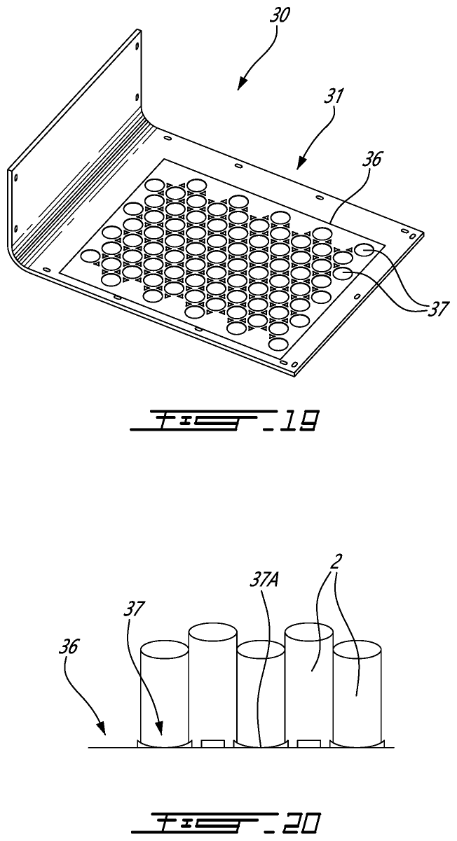

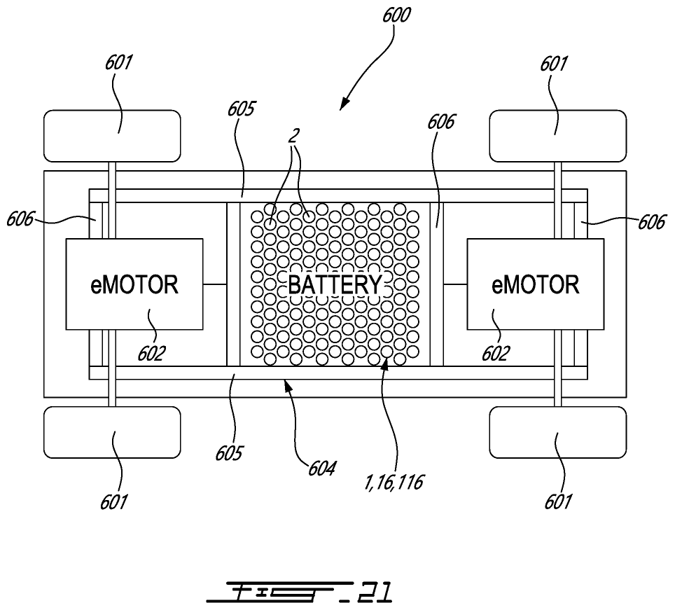

Referring now to FIGS. 19-20, a bottom support 36 may be secured to the first section 31 of the heat-conducting plate 30 for supporting the battery cells 2, that are herein provided with a cylindrical shape. The bottom support 36 defines a plurality of cell-engaging protrusions 37 each protruding from the first section 31 of the heat-conducting plate 30. Each of the cell-engaging protrusions 37 may define a concavity 37A sized for receiving a respective one of the modules 2. These protrusions 37 may be made of a material having a high thermal conduction to transfer the heat to the first section 31 of the heat-conducting plate 30. This material may be, for instance, aluminum. The cell-engaging protrusions 37 may limit movements of the modules 2 in a plane parallel to the first section 31 of the heat-conducting plate 30. This support 36 may facilitate assembly of the battery cells 2 and may improve thermal contact with the heat-conducing plate. The protrusions may extend perpendicularly to the heat-conducting plate to enhance heat transfer normal to the heat-conducting plate. This may reduce the temperature gradient along the battery cells.

The heat-conducting plate 10 described above with reference to FIG. 3 may include any of the features described above with reference to FIGS. 6-18. For instance, the heat-conducting plate 10 may include one or more coolant conduits. A portion of the heat-conducting plate 10 may be wrapped around the one or more coolant conduits.

Referring now to FIG. 21, an electric vehicle is shown at 600. The electric vehicle 600 includes wheels 601, four in the embodiment shown, that are driven by one or more electric motors 602. In the embodiment shown, the electric motors 602 include a front electric motor driving the front wheels located at the front of the vehicle 600 and a rear electric motor driving the rear wheels located at the rear of the vehicle 600. Other configurations are contemplated. For instance, each of the wheels 601 may be drivingly engaged by a respective electric motor. Thus, for a four-wheel vehicle, four electric motors may be provided. Alternatively, a single electric motor may drive all of the wheels 601, via any suitable transmission.

The vehicle 600 has a chassis that generally includes a frame 604 for supporting the electric motors 602. In the embodiment shown, the frame 604 of the chassis includes longitudinal frame members 605 extending longitudinally between a front and a rear of the vehicle 600, and includes transversal frame members 606 extending transversally between a right side and a left side of the vehicle 600. The frame 604 is depicted here as being generally rectangular, but any other suitable shape may be used. The frame 604 may include truss or any other bracing member to provide the required stiffness to the frame 604 while allowing the frame 604 to sustain the different components of the vehicle 600. The vehicle 600 includes a battery pack, which may correspond to any of the battery packs described above.

As illustrated in FIG. 21, the battery pack is load-bearing as defined herein. Consequently, a stiffness of the frame 604 may be increased by the battery pack, and the heat-conducting plate 10 of the battery pack provides a load transmission path through which load is transmitted between other structural components of the vehicle (or the structure within which the battery pack is mounted). Stated differently, the heat-conducting plate 10 of the battery pack is capable of withstanding and transmitting loads during normal operation of the vehicle without buckling or failing. In the embodiments illustrated, the heat-conducting plate of the battery pack may be responsible for increasing the stiffness of the frame 604. In this context, “increasing stiffness” implies that a non-negligible portion of the stiffness of the frame 604 is provided by the heat-conducting plate. Such a non-negligible portion may be, for instance, at least 10% of the stiffness or more (e.g., at least 20% or at least 30%) of the stiffness. Put differently, the heat-conducting plate may increase the stiffness of the frame 604 by at least 10%, at least 20%, and at least 30% in some embodiments. The “stiffness” is understood as including a resistance to the frame 604 to one or more of a flexion force, a shearing force, a torsion force, and so on.

In the embodiment illustrated, one of the longitudinal frame members 605 is secured to another one of the longitudinal frame members 605 via the battery pack and its enclosure 1, 16, 116 including the heat-conducting plate. A load path may therefore be transferred between the longitudinal frame members 605 through the heat-conducting plate. The heat-conducting plate of the battery pack and enclosure may alternatively, or in combination, transfer loads between the transversal frame members 606. The heat-conducting plate may thus act as a web resisting one or more of a shearing force, flexion force, torsion force, and so on applied to the frame 604 of the vehicle 600 during normal use. The battery pack may define a bottom panel of the frame 604 such that the frame 604 may be devoid of a separate distinct panel. The battery pack may thus be secured (e.g., welded, fastened, etc) to the frame 604 directly without requiring an intermediary component. In other words, a typical battery pack may be fastened to a panel which is itself secured to the frame 604. In the present configuration, the electric vehicle 600 is devoid of such a panel such that the battery pack and enclosure, more specifically the heat-conducting plate, acts as a support panel for both supporting the cells 2 of the battery pack and for transmitting and sustaining loads imparted to the frame 604 during use. Moreover, a bottom wall or casing of the battery pack may face downwardly towards a ground and be directly exposed to the environment outside the electrical vehicle 600. The heat-conducting plate of the battery pack may define a face exposed directly to the environment. Thus, the battery pack and enclosure may have the required stiffness and resistance to protect the cells 2 without the need of another structural component of the frame 604. In some embodiments, the heat-conducting plate of the battery pack is responsible for providing the stiffness required to transmit loads between the frame members and to protect the cells 2.

The heat-conducting plate, further to be able to withstand loads imparted thereto by the weight of the cells 2, and may further be able to withstand harsh operating conditions. For instance, the heat-conducting plate may be able to withstand one or more of corrosion, erosion, vibrations, acceleration, impact from foreign object (e.g., gravel, stones, etc). The heat-conducting plate may be manufactured from any suitable material, such as aluminum, stainless steel, and so on and may have a thickness or any suitable reinforcement (e.g., ribs) to withstands those loads and conditions. The heat-conducting plate may comply with UL2271, UL2580, UL1642, UN38.3, ISO12405, IEC 62133, IEC 62660, SAE J2929, SAE J2464, and UL94-VO standards.

Such a configuration may allow weight savings of the electric vehicle 600 since structural frame members may be omitted as their function is now undertaken by the heat-conducting plate. Assembly of the electric vehicle 600 may be facilitated by this omission of some of the structural frame members. Moreover, by being directly exposed to the environment, heat transfer to and from the cells 2 via the heat-conducting plate may be increased since there is no thermal resistance provided by a structural panel of the frame 604, since such a panel may be omitted.

In the context of the current disclosure, the expression “substantially” is meant to encompass differences imparted by manufacturing tolerances. The expression “about” implies variations of plus or minus 10%.

The embodiments described in this document provide non-limiting examples of possible implementations of the present technology. Upon review of the present disclosure, a person of ordinary skill in the art will recognize that changes may be made to the embodiments described herein without departing from the scope of the present technology. Yet further modifications could be implemented by a person of ordinary skill in the art in view of the present disclosure, which modifications would be within the scope of the present technology.

1. A battery pack, comprising:
an enclosure including interconnected walls;
one or more battery cells contained within the enclosure; and
a heat-conducting plate defining one or more of the interconnected walls and being structurally load-bearing, the heat-conducting plate having
a first section, the one or more battery cells in heat exchange relationship with the first section, and
a second section in heat exchange relationship with the first section, the second section in heat exchange relationship with an environment outside the enclosure for providing heat exchange between the one or more battery cells and the environment.

2. The battery pack of claim 1, wherein the one or more battery cells are secured to the first section of the heat-conducting plate.

3. The battery pack of claim 1, wherein the first section and the second section extend transversally to one another and each define a respective side of the enclosure.

4. The battery pack of claim 1, wherein the first section includes a first plate and the second section includes a second plate, the heat-conducting plate including heat pipes mounted to both of the first plate and the second plate, a heat pipe of the heat pipes extending from a first end on the first plate to a second end on the second plate.

5. The battery pack of claim 4, wherein the second plate has an inner side facing the one or more battery cells and an outer side opposed to the inner side, the outer side defining fins.

6. The battery pack of claim 4, wherein the first plate and the second plate define grooves, the heat pipes received within the grooves.

7. The battery pack of claim 6, wherein the first and second plates are made of a material having a thermal conduction of at least 10 W/mK.

8. The battery pack of claim 1, wherein the heat-conducting plate includes:
a first casing and a second casing defining a cavity therebetween;
a core assembly having
a wicking layer adjacent an inner side of the first casing, and
a vapor core, the wicking layer and the vapor core received within the cavity; and
a working fluid within the cavity.

9. The battery pack of claim 8, comprising one or more coolant conduits embedded within the second section, the coolant conduits flowing a coolant and in fluid communication with a cooling system for extracting heat from the coolant.

10. The battery pack of claim 8, comprising one or more coolant conduits, the second section wrapped around the one or more coolant conduits, the coolant conduits flowing a coolant and in fluid communication with a cooling system for extracting heat from the coolant.

11. The battery pack of claim 8, comprising fins protruding from the second section of the heat-conducting plate.

12. The battery pack of claim 8, comprising a third section, the first and third section connected together via the second section, the first, second, and third sections defining a U-shape, the one or more battery cells located between the first and third sections.

13. The battery pack of claim 8, wherein the first section includes four lateral sections each extending generally transversally from a respective edge of the second section, the four lateral sections and the second section defining the enclosure.

14. The battery pack of claim 1, comprising a battery support secured to the first section, the battery support defines a plurality of cell-engaging protrusions each defining a cavity receiving a respective one of the one or more battery cells.

15. An electric vehicle, comprising:
a chassis including a frame having frame members; and
a battery pack secured to the frame, the battery pack having:
an enclosure including interconnected walls;
one or more battery cells contained within the enclosure; and
a heat-conducting plate defining one or more of the interconnected walls and being structurally load-bearing and configured to increase a stiffness of the frame, the heat-conducting plate having
a first section, the one or more battery cells in heat exchange relationship with the first section, and
a second section in heat exchange relationship with the first section, the second section in heat exchange relationship with an environment outside the enclosure for providing heat exchange between the one or more battery cells and the environment.

16. The electric vehicle of claim 15, wherein one of the frame members is secured to another of the frame members via the heat-conducting plate.

17. The electric vehicle of claim 15, wherein the heat-conducting plate has a bottom face exposed to an environment outside the electric vehicle.

18. The electric vehicle of claim 15, wherein a stiffness of the frame is increased by the heat-conducting plate by at least 10%.

19. The electric vehicle of claim 15, comprising brackets, the heat-conducting plate secured to the frame members via the brackets, a load path extending from the frame members to the heat-conducting plate via the brackets, the brackets configured to support a weight of the battery pack.

20. The electric vehicle of claim 15, wherein the heat-conducting plate is configured to support a weight of the one or more battery cells.
